(19) United States
(12) Patent Application Publication
(10) Pub. No.: US 2015/0220516 A1
(43) Pub. Date: Aug. 6, 2015

(54) METHOD AND SYSTEM FOR PROVIDING RELEVANT PORTIONS OF MULTI-MEDIA BASED ON TEXT SEARCHING OF MULTI-MEDIA

(71) Applicant: CAPTIONING STUDIO TECHNOLOGIES PTY LTD, Adelaide, South Australia (AU)

(72) Inventor: Alex French, Adelaide (AU)

(21) Appl. No.: 14/421,839

(22) PCT Filed: Aug. 16, 2013
(86) PCT No.: PCT/AU2013/000917

§ 371 Date: Feb. 15, 2015

(30) Foreign Application Priority Data
Aug. 16, 2012 (AU) 2012903528

(51) Int. Cl. G06F 17/30

(52) U.S. Cl. CPC G06F 17/3005

(57) ABSTRACT

It is known to provide a database and a search facility to search within a database and to be directed to the source of the information determined by the search to be of relevance. However, sometimes despite the ability to search and locate information, that information is not available to those that do not have the authority to access that information. In the case of multimedia files it is not uncommon to have to subscribe to the service that provides the multimedia file. The invention provides an application having processes that enable a user to not only search for and locate relevant multimedia files or portions of multimedia files but to access selected multimedia files using a control server service which has pre-organised authority to make access to selected multimedia, in one example, without the user needing to be preauthorised to do so, or in the case of a user having that preauthorisation, seamless access to requested multimedia while being able to search and access multiple sources of such multimedia whether they are preauthorised or not with those other sources of multimedia.

### FIELD OF THE INVENTION

The field of the invention is the provisioning of access to multimedia using computers and computer networks.

### BACKGROUND

It is known for a supplier of multimedia to provide a search capability so that a user, being a casual or subscriber to the service provided by the supplier, can search and possibly rank the results of the search. The user then has one or more options to view the multimedia presented in such a manner as to allow the user to view only, download, or save for future review the multimedia selected.

Not all multimedia includes audio nor does it include captioning of the spoken word included in the audio or metadata which exists or is added to assist digital or human searching, categories or further computer performed processing, although it is possible to add such data to existing multimedia. When such data is available it is then possible to conduct searches using text and terms to identify whether a particular multimedia file contains (including in its metadata) those terms or text and provide search results, which can be displayed, manipulated (e.g. ranked) according to one or more criteria..

PCT/AU2011/000332 published as WO2011/116422 is owned by the applicant of the subject application and is incorporated by reference into this specification. The referenced patent application discloses a method of searching recorded multimedia content (file), including the steps of, analysing a respective time coded transcript or time coded speech metadata, of at least two sources of recorded multimedia content to identify potentially relevant portions thereof based upon a search request from a user, and access to the time coded transcript or time coded speech metadata, being controlled by the search provider, and including displaying the details of the potentially relevant portions to the user so that the user is able to select a portion or portions of the sources of recorded multimedia content for review.

What is not available is the ability to search within collections of multimedia files (free or restricted multimedia) to locate relevant portions of those files and the ability to review those relevant portions wherever they may be stored even if there are restrictions to access to that file.

The reference to any background or prior art in this specification is not, and should not be taken as, an acknowledgment or any form of suggestion that such background or prior art forms part of the common general knowledge.

### BRIEF DESCRIPTION OF THE INVENTION

In a broad but not the only aspect of the invention an application for execution on a third party server for providing access to multimedia file which is associated with the third party server, wherein the application interacts with a control server from which a user client is served the results of a respective user determined search, wherein the results of the search are associated with at least the following data, the start position of a portion of a multimedia file associated with the third party server, an authorisation credential operable to permit access to the third party server and the multimedia file content thereon, and an external address of an application on the third party server, wherein the user indicates to the control server which result and associated data is to be served to the user client from the externally accessible address of the multimedia file on the third party server, the application including executable code to process data associated with the user selected result, including the steps:
a) receiving from the control server a search result
b) displaying the search result to a user using the user client;
c) receiving the user selection of a result;
d) authenticating the user client to permit access by the user client to the selected multimedia file at the start position indicated by the search result;
e) communicating the selected result to the control server;
f) receiving from the control server the URL of the selected multimedia file and the start position within the selected multimedia file;
g) generating a time-limited URL for the selected multimedia file;
h) communicating the time-limited URL and start position to a media player on the user client.

In further broad aspect of the invention an application for execution on a third party server for providing access to multimedia file which is associated with the third party server, wherein the user indicates to the control server which search result is to be served to the user from a third party server wherein the selected result of the search is associated within the control server with at least the following data, the start position of a portion of a multimedia file associated with the third party server, and data relating to the user client useable to permit access by the user client to the multimedia file content, and an externally accessible address of the application on the third party server, the application including executable code to process data associated with the user selected result, including the steps:
a) receiving from the control server the address of the application on the third-party server and a request to serve to the user client a web page including a media player, the request including data representative of the selected result of the search;
b) authenticating the user client to permit access of the user client to the selected portion of the multimedia file at the start position indicated by the search result;
c) generating a time-limited URL for the selected portion of the multimedia file based on data representative of the search result;
d) communicating the time-limited URL and start position to a media player on the web page.

It should be appreciated that the present invention can be implemented in numerous ways, including as a process, an apparatus, a system, or a computer readable medium such as a computer readable storage medium or a computer network wherein program instructions are sent over wireless, optical, or electronic communication links. It should be noted that the order of the steps of disclosed processes may be altered within the scope of the invention.

Details concerning computers, computer networking, software programming, telecommunications, and the like may at times not be specifically illustrated as such were not considered necessary to obtain a complete understanding nor to limit a person skilled in the art in performing the invention, are considered present nevertheless as such are considered to be within the skills of persons of ordinary skill in the art.

A detailed description of one or more preferred embodiments of the or each invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the disclosure herein encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

“Software,” as used here in, includes but is not limited to 1 or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, a plug-in, instructions stored in a memory, part of an operating system or other type of executable instructions. It will be appreciated by one of ordinary skilled in the art that the form of software is dependent on, for example, requirements of a desired application, the environment it runs on, and/or the desires of a designer/programmer or the like.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs); processors, controllers, micro-controllers, microprocessors, other electronic units designed to perform the functions described herein, or a combination thereof. Software modules, also known as computer programs, computer codes, or instructions, may contain a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be, implemented within the processor or external to the processor, in which case it can be communicatively coupled to the processor via various means as is known in the art.

Specific embodiments of the or each invention will now be described in some further detail with reference to and as illustrated in the accompanying figures. These embodiments are illustrative, and not meant to be restrictive of the scope of the invention. Suggestions and descriptions of other embodiments may be included within the scope of the invention but they may not be illustrated in the accompanying figures or alternatively features of the invention may be shown in the figures but not described in the specification.

### BRIEF DESCRIPTION OF THE FIGURES

FIG. 1 depicts a system diagram of an embodiment of the invention;

FIG. 2 depicts a search user interface as viewed by a user on the screen of their computer device which may be supplied by a control server or a third party supplier;

FIG. 3 depicts a user's screen having the search window of FIG. 2 and a multimedia playback window;

FIG. 4 depicts a system diagram that illustrates a particular part of a user interface displayed on a user screen and various searching databases accessible by the user's computer device;

FIG. 5a depicts a flow diagram of one method embodiment of the invention;

FIG. 5b depicts a flow diagram of another method embodiment of the invention;

FIG. 6a depicts a long form of a Uniform Resource Locator;

FIG. 6b depicts a short form of a Uniform Resource Locator; and

FIG. 7 depicts various servers and APIs that control and deliver analytics created and logged in the system.

### BRIEF DESCRIPTION OF EMBODIMENTS OF THE INVENTION

The invention the subject of this specification relates to the making available to a user a desired portion of a multimedia file (where a portion can include the whole of the media) using the services of the source of the multimedia wherein the supplier of the search facilities is involved in the process.

A multimedia file can represent, although this description should not be used to unreasonably restrict the scope of such files as used within this invention, can include a file containing one or more mediums of human expression or communication, and by way of example only, includes a file having both audio and video, or a file having audio, text of the audio in one or more languages and video, or a file having audio, video, and static images such as a data presentation, or a file having two video images played concurrently and sequenced audio. As will be known to those of skill in the art there are and can be many variations of the content of a multimedia file. It would not be obtuse to indicate that a file having only one expression of communication is still a multimedia file as all such files will also include a metadata portion, which can include, machine and human readable data, representative of, for example, title, date of creation, size, etc. and possibly other data such as text representative of the audio, abstract of the content, etc.

There exist a number of ways by which the seemingly simple process of making multimedia available to a user can be achieved. It is known to provide a database and a search facility to search within a database and to be directed to the source of the information determined by the search to be of relevance. However, sometimes despite the ability to search and locate information, that information is not available to those that do not have the authority to access that information. In the case of multimedia information it is not uncommon to have to subscribe to the services provided by a source of multimedia to access the multimedia file. The invention provides an application having processes that enable a user to not only search for and locate relevant multimedia or portions of multimedia but to access selected multimedia using a control server service which has pre-organised authority to make access to selected multimedia, in one example, without the user needing to be preauthorised to do so, or in the case of a user having that preauthorisation, seamless access to requested multimedia while being able to search and access multiple sources of such multimedia whether they are preauthorised or not with those other sources of multimedia.

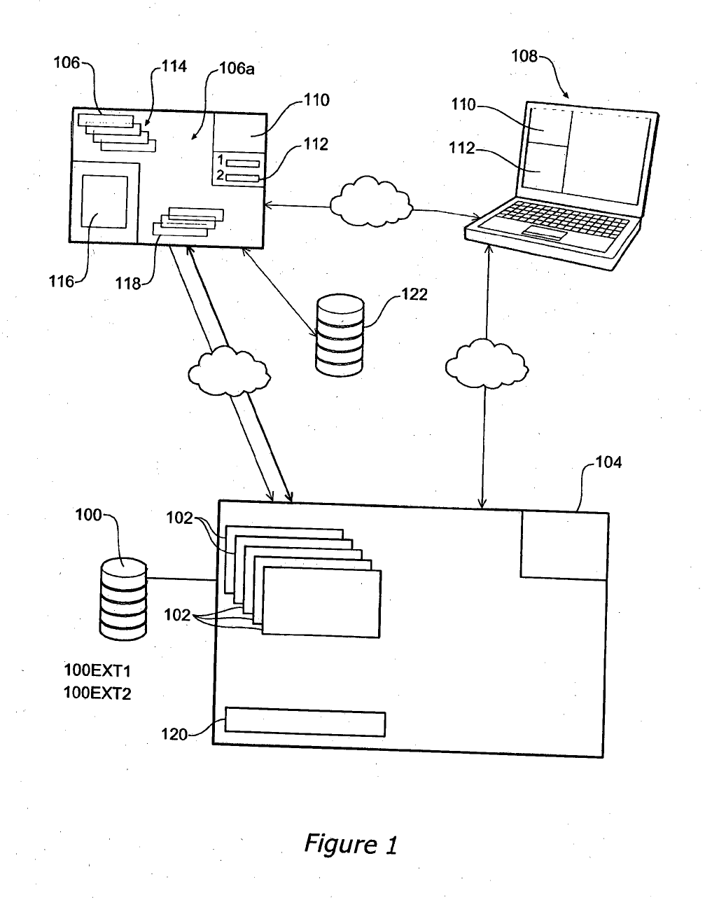

To facilitate that process, in one embodiment, there are a number of system requirements, and referring to FIG. 1 as an example of one embodiment, there is depicted a third party server 100, which is configured to provide to users (casual or subscribers) access to multimedia files 102 which are in one embodiment stored locally and in another embodiment served remote from the source of the file at a remote location 100ext1 and/or 100ext2 accessible by the server using a network, for example a WAN or as one alternative the Internet.

FIG. 1 also depicts a control server 106 which in this embodiment controls the searching process either on that server or as a service to a third party server. In the latter case, the control server, could in one embodiment open up a session via a web based protocol on the third party server and appear to a user of the third party server on a third party supplied web access page to be using a search facility provided by the third party server, when in fact the search is being conducted by the control server. More about this aspect of the embodiments will be described later in the specification. The control server can include its own collection of multimedia files 114 and applications 118, such as web server applications, API's for various purposes, etc. The web server application can be used to server the search interface 110 and the search results interface 112 (FIG. 1).

The images of a cloud are representative of a network of computers that is commonly referred to as the Internet. The use of three clouds does not mean that there are three separate computer networks as the Internet is so ubiquitous and readily available to user clients and servers suitably configured and hardware equipped, but it could mean that there are different network protocols and hardware configurations used by respective servers and user clients. As such there are many digital communications protocols and hardware devices for facilitating digital communications between the computer servers and computer devices involved in the system that supports the invention. The configuration of digital communications is not the subject of this invention but the use of them is well known to those of skill in the art.

FIG. 1 also depicts a user computer device, a laptop computer (having computer hardware therein and various user interfaces, such as a screen for display of information, and a keyboard and pointing device for user entry into the computer). A laptop computer is illustrated but the computer could be a computer server, a computer device within a mobile phone, and many other forms of computer. The user's computer device will have at least a CPU and memory (not shown) in addition to the user interfaces described above, and resident within the computer memory at least one executable software program referred to herein as a user client (pictorially represented by 115 in FIG. 1). The details of some of the processes performed by the user client will be described in detail later in this specification, but one such process is the provision on the computer device of a web browser (one skilled in the art will readily appreciate how this is provisioned and how the user's computer can provide input to the browser displayed to the user on the computer screen), and another processes of the user client include receipt of data from various sources, including the third party server 100 and the control server 106, yet further the user client is used for communicating with the mentioned servers and others.

Some of the multimedia files 102 may include timed text (which is transcription with timing information and one example is captioning or subtitling), meaning that the spoken words contained in the multimedia file have been converted to text and are available with the file along with the time they occurred within the multimedia file. In one example the text is associated with the file in the form of metadata and can then be displayed in synchronisation with the spoken words during replay of the multimedia file. It is also possible to provide the multimedia file for searching, so that not only timed text is searchable but so is any other data associated with the file, such as its title, caption text, duration of the multimedia file playback, the actual UTC or local time at which during the file playback that one or more terms are spoken, the abstract, speaker names, topics covered and other key words, as well as non-verbal information that can be digitised, such as sign language, geographic information, place names, business/es associated with the multimedia, places of interest, images used in conjunction with the multimedia which could include concurrent presentation images, graphs, video, audio, etc. all of which can be searchable. Additionally one or more frames of the video in the multimedia file can be used to visually represent the file as there can be various characterisations of those frames which can also be searched.

Searching can be a very complex process and there are many ways, in which to conduct searches and this is not the subject of this specification. However, it is intended in at least one embodiment that the provisioning to a user client of a desired portion of the multimedia be done via the entity that conducts the searches or direct from a third party server which is the source of the multimedia.

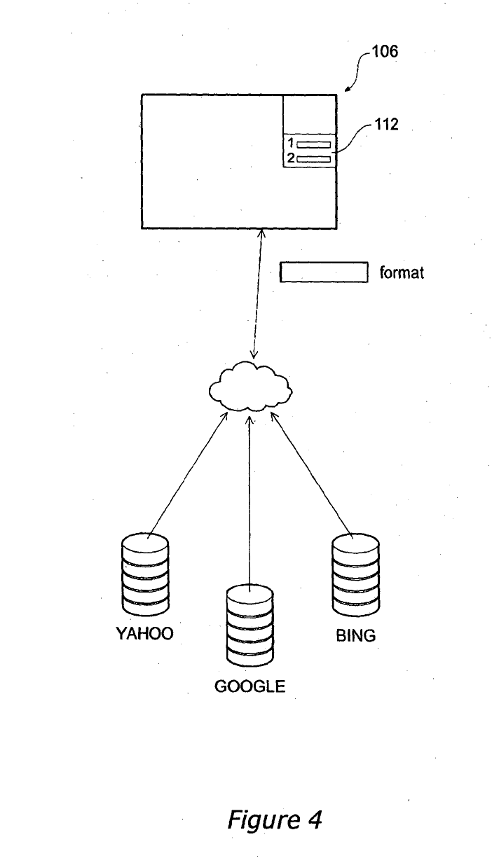

Search results can be supplied from searches done locally on the control server or done by another entity such as illustrated in FIG. 4.

Searching can be initiated in many ways one of which can include a mechanism to identify likely keywords of interest in the multimedia file or one or more portions of those multimedia files 102 including text, and offer searches and search results based on those keywords.

In an embodiment, there is a control server 106 having access to multiple multimedia files and/or their respective associated metadata, either or both which may be physically located locally, physically located on third party servers or include pointers to the source of the multimedia file and respective associated data available locally for searching purposes. Thus it is not necessary for the physical files to be local to the control server 106 for them to be searchable. In fact it is possible for other parties to provide search results to the control server to include in the search results presented to a user using the control server search facility. For example, a search service such as Google (see FIG. 4) has the ability to search data such as that considered above, however, it is not always able to authorise access to the multimedia or portions of the multimedia that are of interest to a particular user.

The control server thus has the ability to make available one or more search results 112 to a user who accesses the control server 106 from a client computer device 108 in FIG. 1 depicted as a personal computer but could alternatively be a mobile computer device such as a so called smart phone, or a tablet computer having the mentioned user client program. The program on the control server or in some examples the third party server that provides the ability for a user using a user client to conduct a search can be made available in many forms, and one example is the use of a web browser session 110 served to the user client on the user's computer device which can be configured to access a web page or pages on for this example, the control server 106 behind which is the database and search code and behind which can also be a third party server having access to the multimedia files of possible interest to the user. It is also required that the user be able to indicate to the control server a choice of the one or more search results that they want to view using the user client operating on the user's computer device.

Of course the control server is designed to service multiple user devices and third party servers but the illustrations and description used in this specification, only shows and describe one of each to simplify the description and de-clutter the illustrations.

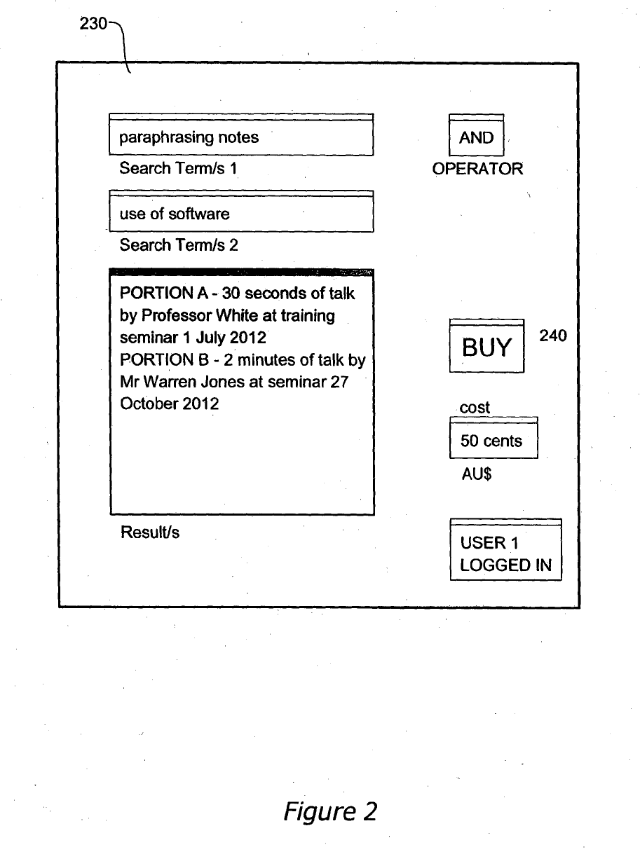

The user can construct a search enquiry, which will be likely to provide relevant results. One example of such is a search within a collection of training multimedia presentations and their associated metadata, for verbal phrases used by the trainers relating to “paraphrasing notes” and “use of software to paraphrase” As depicted in FIG. 2 a search tool having a number of fields into which a user using their user client and associated web page, as well as the user interfaces and devices, such as a keyboard and pointing device can enter data into those fields, in addition to which there exists an OPERATOR option, and in this search example the AND operator is selected by the user. ANDing requires that both phrases in the respective fields exist within the multimedia file portion to be searched for. Other OPERATOR's include NOT, OR, EQUALS, FUZZY MATCH, etc. as will be known to those of skill in the art.

In one example of a search result, the following multimedia portions were identified:

ID12345<Start Time (1:01) 1 minute 1 second into source=Start Cue-1:01><Period of portion 30 seconds><multimedia file As*34>source media file www.thirdpartyserver.com/As*34 <Credential $%#̂&̂>

Presented to the user as—PORTION A—30 seconds of talk by Professor White at Training Seminar 1 Jul. 2012—in the form of a hyperlink actionable by the user if they wish to select that portion.

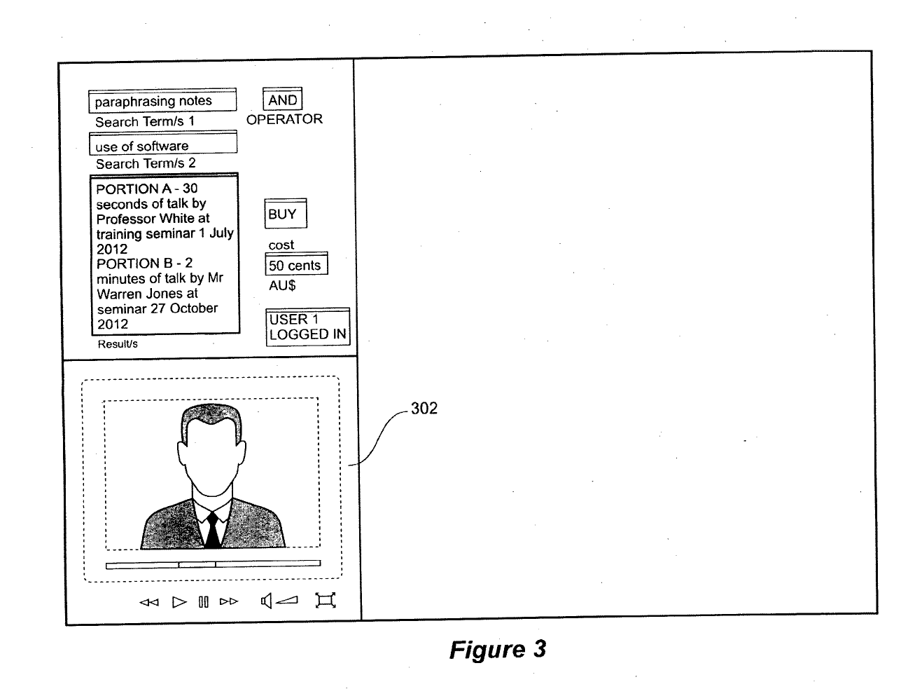

In FIGS. 2 and 3 this presentation of the portion is highlighted to depict its selection by the user behind which is a URL.

ID12233<Start Time (1:23) 1 minute 23 seconds into source=Start Cue-1:23><Period of portion 2 minutes seconds><multimedia file GT&64>source media file http://www.thirdpartyserver2.com/AH6R2<Credential $T4#0̂>

Presented to the user as—PORTION B—2 minute of talk by Mr Warren Jones at Seminar 23 Oct. 2011—in the form of a hyperlink actionable by the user if they wish to select that portion.

Note that a timed length the portion is used in this example, but it would also be possible to use data that represents the end point of the portion. For example, in PORTION A the data could be <Start Time (1:01) 1 minute 1 second into source><Finish Time (1:31) 1 minute and 31 seconds into source>. This format of data is sometimes referred to in multimedia terms as the In-Cue and Out-Cue data.

As mentioned previously the search results can be presented in a particular part of the user interface 230 using the user client (FIGS. 2 and 3) to the user for selection, using their computer device. The results can appear with an area on the screen of the user's computer device, and in an embodiment, the area is a portion of a web page served by the third party server to the user client in the user's computer device, even though the search results have been generated by the control server.

Activation of a selected hyperlink (FIG. 2) associated with a search result is the beginning of a number of processes dependent on the existence of an application located on the third party server so that the search result representative of selected portion of the multimedia can be provided to the user in one example in a multimedia playback viewing area on the screen of the user's computer device (window) 302 (FIG. 3) which includes in one embodiment a multimedia player. The multimedia viewing area (window) 302 of FIGS. 3 and 112 of FIG. 1, can be configured to merely display a streamed version of the chosen portion, or in fact be an application to playback the format of the chosen portion of the multimedia file which can then include the native PLAY, STOP, FAST FORWARD, FAST REVERSE and PAUSE controls, window expansion and volume controls as well. The multimedia file may only be streamed so there is less likelihood that the user can store the portion, but it can also be arranged for the portion of the file to be downloaded and stored on the user's computer device (at least initially). It is also possible for the link to the multimedia portion and start position to be provided as say a bookmark. Although the link is a time limited URL (as discussed herein) it would also be possible to include a further link to the control server to re-charge for the repeat viewing of the multimedia portion, or to the third party server for much the same process but with reporting steps to the control server so that records can be maintained of user use and re-authentication of that user, etc. in accord with the processes described herein.

In one embodiment the search by a user is conducted on the control server and the user chosen result is played in the user's browser initiated by the third party server by that server permitting access to the chosen portion of the multimedia from the third party source of that chosen result. This embodiment ensures that the control server is involved in the supply of the result to the third party server and that if authority to play the portion of the multimedia is required the application on the third party server authenticates the user to use that portion of multimedia from the nominated start position.

In another embodiment the third party server hosts the search function but that search function is conducted by the control server which is transparent to the user of the third party server.

In each embodiment the application on the third party server issues a time-limited Universal Resource Locator (URL) and the start position of the portion to permit access by the user client to the respective portion of a multimedia file.

The term. URL is well understood and includes within its definition a formatted text string used by Web browsers, email programs, and other software to identify a network resource on the Internet. Network resources are files that can be Web pages, other text documents, graphics, multimedia files, or programs.

A time limited (sometimes also referred to as very-short-lived) URL is used by way of example in this specification as a URL with a time limit on its validity, for accessing the multimedia portion. This approach is primarily a security measure and a practical measure to ensure that the access provided to a multimedia file or a portion thereof, located in or accessible by a third party server, is acted on substantially concurrently with the needs of the user wanting to view the multimedia portion and thus reduce the likelihood that others without authentication do not also access the relevant multimedia portion. This applies whether the portion is normally free or of a restricted access type.

There is also an embodiment which includes a non-transitory machine-readable medium (such as a memory of a computer). The medium may in one embodiment comprise a plurality of machine-readable instructions which, when executed by one or more processors, are adapted to cause the one or more processors to perform a method according to the invention.

In one embodiment the application for execution on a third party server provides access to multimedia file which is associated with the third party server.

The application interacts with the control server from which a user client is served the results of a respective user determined search as described above.

The results of the search are associated with at least the following data:

the start position of a portion of a multimedia file associated with the third party server,

an authorisation credential operable to permit access to the third party server and the multimedia file content thereon, and

an, external address of an application on the third party server.

The user indicates to the control server the result and associated data to be served to the user client from the externally accessible address of the multimedia file on the third party server.

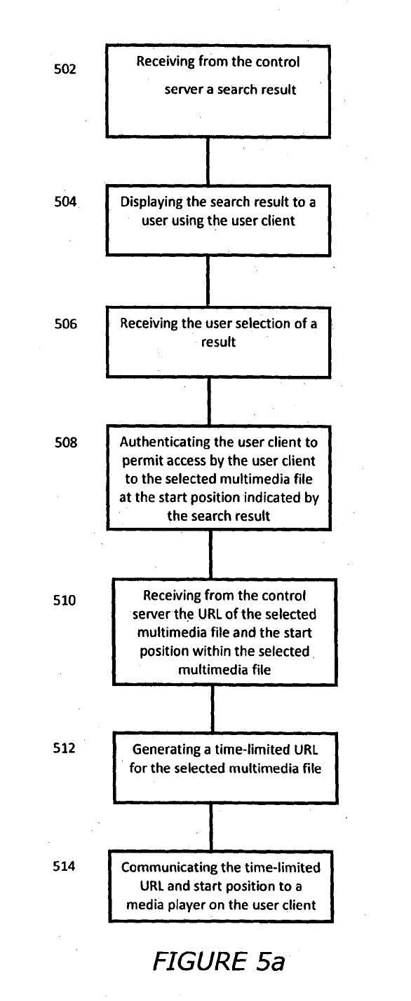

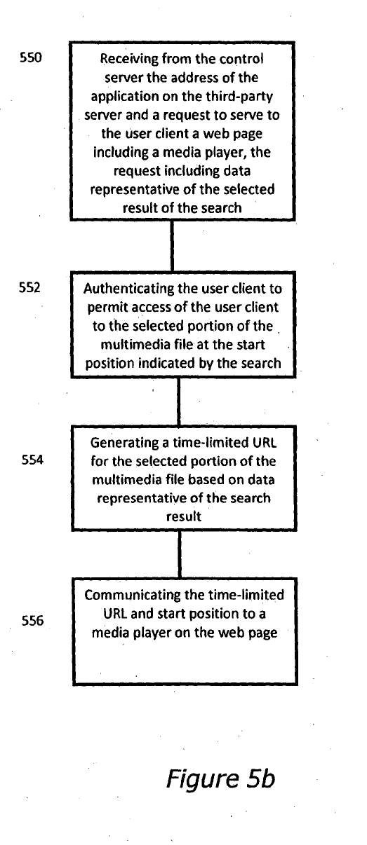

The application includes executable code to process data associated with the user selected result, including the steps (referring to FIG. 5a).

Step 502 the application receiving from the control server a search result which can be in the form depicted above.

Step 504 displaying the search result to a user using the user client which can be in the form depicted in FIGS. 1, 2 and 3.

Step 506 receiving the user selection of a result by the application which can be in the form of the physical action of a user using an interface device such as a pointer or cursor control device clicking or hovering or speaking (according to a preferred way of that user interacting with their computer device) on a represented selected search result which has the form of a URL including various data.

Step 508 authenticating the user client to permit access by the user client to the selected multimedia file at the start position indicated by the search result, which is required to ensure that the user or the control server has provided authentication data acceptable to the third party server to allow access to the particular multimedia and the start position. The allowability of that action can depend on a number of characteristics which, in no particular order or importance, can include, whether the user has pre-organised authority to access that particular multimedia from the particular start position, whether if not the control server has pre-organised authority to access that particular multimedia from the particular start position, and none, one or more characteristics which may also include encryption and decryption of authentication data, codes or keys associated with the data exchanged between the servers. The described actions and other administrative actions all occur in the background unseen by the user and almost instantaneously so that the user does not notice any unacceptable delay between actuating the selected search result and being server the link or multimedia represented by the search result.

Step 510 communicating the selected result to the control server so that in one form of an embodiment of the process the control server can be aware of the selection for record keeping purposes and in another form for allocating additional data to the search result such as the specific URL of the selected multimedia file, the start position within the selected multimedia file and other data that can be used by the third party server.

Step 512 the application on the third party server receiving from the control server the URL of the selected multimedia file and the start position within the selected multimedia file.

Step 514 the application generating a time-limited URL for the selected multimedia file which acts in one embodiment in the manner described previously.

Step 516 the application communicating the time-limited URL and start position to a media player on the user client which in one form is a command provided via an existing web session between the user client and the third party server, which is able to command a compatible player for the particular multimedia file type. Since there a many different multimedia file types the calling of the relevant compatible and its location on the user's computer display device is a matter well known to those of skill in the relevant art.

In another embodiment the application for execution on a third party server provides access to multimedia file which is associated with the third party server.

The application interacts with a user who indicates to the control server which search result is to be served to the user from a third party server wherein the selected result of the search is associated within the control server with at least the following data:

the start position of a portion of a multimedia file associated with the third party server, and data relating to the user client useable to permit access by the user client to the multimedia file content, and

an externally accessible address of the application on the third party server.

The application includes executable code to process data associated with the user selected result, including the steps (referring to FIG. 5b).

Step 550 the application receiving from the control server the address of the application on the third-party server and a request to serve to the user client a web page including a media player, the request including data representative of the selected result of the search.

Step 552 the application authenticating the user client to permit access of the user client to the selected portion of the multimedia file at the start position indicated by the search result, in one form in the same manner described above.

Step 554 the application generating a time-limited URL for the selected portion of the multimedia file based on data representative of the search result, in one form in the same manner described above.

Step 556 the application communicating the time-limited URL and start position to a media player on the web page, in one form in the same manner described above.

The third party server may have one or more processors and associated, memory (see FIG. 1 116) to provide the computer power to provide the steps of the method/s described herein. Similarly the control server and even the user's computer device will have processors and memory to support the functionality described in this specification. It is well within the skill of the person to use those processors and memory to execute software code that changes the environment within the processor to uniquely transform the processor's and memory to function as required by the method/s described.

There are many ways of collecting and sharing relevant portions of multimedia, as described previously, and in one further example, applicable to the results generated by one or many users, particular key words can be selected to trigger an automatic generation of aggregated content. The aggregation (sometimes referred to as curation) may be automatic or created manually by a user.

Once different aggregations are created by multiple users the aggregated data may be used to create alerts to subscribers to the control server services or a third-party source.

Aggregations (even of freely available content) may be provided on a subscription basis to subscribed users to either the control server service or to a third party server service.

Automatic aggregation may be controlled for example by popular keywords input by users, users search results which are distributed by various means, and various social media services which re-broadcast various links to particular portions or aggregations and thus it is possible that trends will become apparent further encouraging the viewing of particular portions of multimedia, bookmarking of particular portions or aggregations, analytics on the aggregations, and content owners choice of keywords or content can be readily distributed using social media and the like.

Aggregation may also be based on complete videos, e.g. one or more important keynote speeches.

A user may aggregate content at the time of playback (i.e. portions linked) and may then be played one after the other, or may be edited into a single media item (if a license relating to the multimedia allows this of course) and then played back via the control server or the third party server.

The aggregated portions will likely be linked to the originating site for copyright reasons.

It is possible for there to be a mechanism to identify related video and text content using the spoken word text or the person speaking (for example, using speaker recognition or face recognition), or using timed text in a translation of the audio track, noting that the language of the spoken word in the media may not be English) in the portions to identify and create relevant links. Searching by a particular program executing on the control server would locate keywords, key-phrases, persons or words in a timed translation of the spoken word, and then it would be possible to identify top ranking search results from other search engines, and/or use other video results from the control server site that relate to those keywords or recognised faces. As each portion is played, the page would update to show links to that related content.

In one example it would be possible to serve advertising where the advertisements are related to the content portions included in the relevant portions.

Whether the user is permitted access to a selected portion directly from and playable on the user's computer device, or the control server effectively relays/streams (for example the playback is embedded in the control server) the portion from the third party server, or some other arrangement is used, is dependent on a number of factors, some of which will be described herein.

Further, the user may or may not be given access to the relevant portion of multimedia since the source multimedia file may only be available to subscribers to the multimedia files or have access to one or more levels of restricted multimedia based on their subscription level.

In an example, the user has selected PORTION A that is only available to subscribers to the third party server and selected subscription only multimedia files thereon, and in this example the user is not a subscriber. In that case the control server can arrange access because of a predetermined arrangement, which allows the control server the required access to the relevant multimedia file and thus enables the user to access the selected portion of that file.

In an example, the user has a subscription with the service provider in control of the control server. In particular the subscription for this user is at the highest level available which allows that user to access any of the third party server service providers individually or that have an arrangement with the service provider in control of the control server.

A user that only wishes to access the selected portion only once but does not have user access to the files or portion/s of a multimedia filth provided by a third party server, it is possible for them to be made accessible from that server using authorisation provided by the control server. If the control server has a prearranged agreement with the third party server provider, it is then necessary for the user to have an arrangement with the control server supplier, which could be a subscription that will cover random access to multiple third party server files (typically those not normally available to that user), or by using an immediate BUY option, as depicted in FIG. 2. There are many ways in which these faculties can be arranged which are not the subject of the invention described herein.

The application 104 (FIG. 1) located on a third party server includes executable code to process data associated with the user selected result. Clearly the representation in Figure one is pictorial as the form of the application can be one or more of many, such as for example, code downloaded from the control server as a plug-in to a web server program on the third party server, the application could be in the form of a hard coded ASIC, or stored on a portion of the memory of the third party server. The preferred form is a downloadable plug-in so that the commercial and technical implementation of the system can be readily controlled by a control server.

Various typical authentications can then be communicated between the servers as required, including for example, the exchange of certificates used for encrypting communications between the servers, authenticating the servers, both ways to permit access or exchange of data associated with the method of the invention.

The recorded data of various actions by for example the users, the third party servers, etc. can be stored locally 120 (FIG. 1) and it can also be communicated to a data store 122 (FIG. 1), for example, associated with the control server. Wherever that data is stored it can be analysed to extract useful information, which in some cases can be on-sold to others.

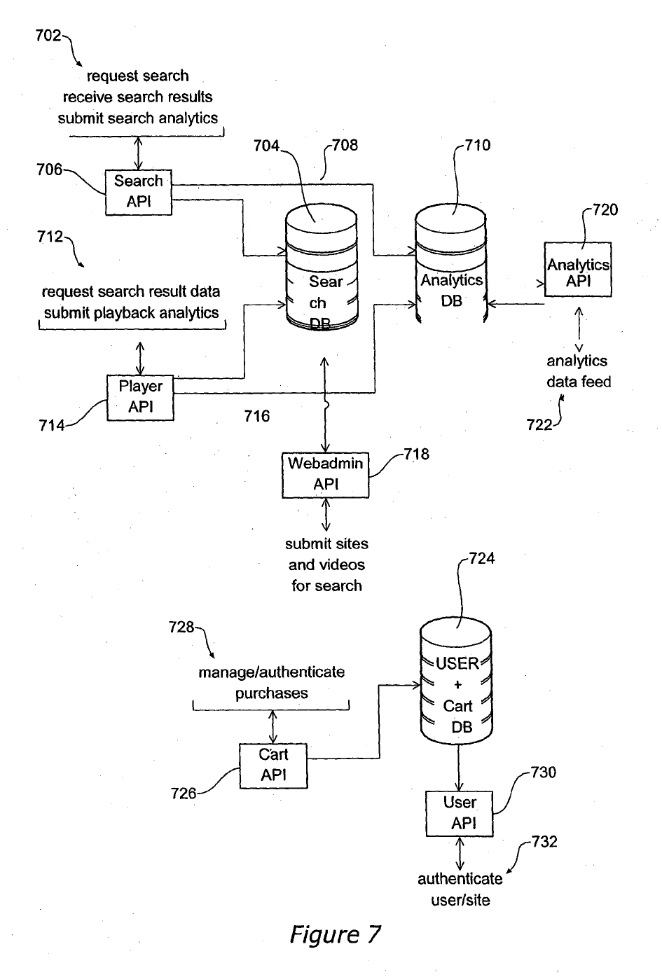

FIG. 7 depicts a collection of servers and Application Program Interfaces (APIs) specify how software should interact with other software and can be arranged and configured to share data relating to the use characteristics of users (through one or more user clients) as well as what users pay for. Requests 702 for searches using the appropriate API 706 that originate on the control server using the control server search results database 704 can be communicated 708 to an analytics database 710. Further, any request 712 for portions that originate from external of the control server, such as requests from social media servers that result from the Tweeting of the URL that contains a prior search result, or a request for a portion that originates from a search conducted via a third party server, is received by an appropriate API 714. That API in turn serves the search result to the search results database 704 to confirm the veracity of the search result request (that it still exists and is available to the requester) and also communicated 716 to the analytics database 710. It is also possible to supply search results stored on the search results database 704 to one or more search engines via the API 718, as also depicted in FIG. 4.

The analytics database 710 can then be queried by an analytics API 720 to provide a wealth of information via an analytics data feed internal of the control server environment and to external entities such as third party services providers. The type of information available is worth paying for and hence there is a need for a payment arrangement a version of which is depicted as a user and third party purchase cart database 724. This database is arranged to function with the cart API 726 to manage the recordal of supply of portions and analytics data to users and third parties, while the user API 730 manages the payments for BUY and level of service supply to users 732. Each of the APIs 726 and 732 include mechanisms to manage authentication of the control server APIs with various third party servers and their APIs.

The application 104 (FIG. 1) also associates the recorded data with the, or a part of the, authorisation credential so that when that data is communicated elsewhere, in an embodiment, the control server will make an association between that data and the control server used to serve the portion and the particular user using the portion that was selected and that association assists the collection of various data regarding the use made by users of the functions available not only from the control server but also of the functions available from the third party server.

The application also allows the third party server to be programmed to tag one or more aspects of the multimedia they have control of so that the tag can be associated with the collected analytical data that is collected and communicated by the application. By way of example the speaker rather than the specific multimedia may be tagged so that the popularity of a speaker can be more easily recorded and tracked.

It may also be that a particular user has prearranged access to one or more third party servers in which case that user can provide their own credential to the third party server.

In a further embodiment there are a number of ways in which a user can be provided search results one of which is the provision of results via a search engine, such as for example Google, Yahoo, or Bing, as depicted in FIG. 4. The data on which those search engines base the search result is supplied to the search engine by the control server, based on the data it has access to. Each major search engine can receive data from third parties in a predetermined format, which in this example, may be unique to the control server and or each third party. The search engine is then able to make data available that might not otherwise be available using the search engine's own data collection methods. This arrangement benefits both the search engine provider, control server and the third party for all or a selected part of their collection of data. If the data becomes part of a search result displayed to a user, the link provided by the search engine provider will take the user back to the control server or the third party, i.e., the source of the data.

Once the user is using the control server, usually via web browser access facility, that user can be encouraged to use the services of the control server or just to use the portion of multimedia that they believe is relevant, if that portion is freely available. That portion can then be made available from the control server if the multimedia player can be embedded on that sever or streamed from its source via the control server to a media player provided by the third party server within the served web page to the user client on the user's computer device.

In yet a further embodiment a particular third party service supplier, which makes available whole multimedia but not portions or search facilities for locating timed multimedia, can use an application on the third party server configured to allow a user to conduct a search using a database and identify the whole or a portion of possibly relevant multimedia on or available from the third party server. The mechanism by which the user conducts the search can vary.

In one embodiment the application provides a search facility on the third party server to the user (wherein the user may not even realise that the facility is not being supplied by the control server) that directs all search terms input by the user to the control server, and which uses its search provision facilities to conduct the search and return results to the third party server. This arrangement keeps the user on the third party server, as the user will not realise that another server is providing the search facilities and results.

In another embodiment, the users' actions are passed over to and wholly within the control server by the application running on the third party server and the user selection of the most relevant result is detected and acted upon by that control server, and access to the selected portion of the multimedia file is actually controlled by the application on the third party server. In this embodiment there is still a requirement to use authorisation credentials 130 (FIG. 1) received by the third party server which can be in addition to any server to server credential checking which is common when servers are exchanging data. The exchange between servers, if successful, allows authentication by the control server that the request for searching to be conducted on the control server, is legitimate and in return, any data returned by the control server to the third party server is legitimate, all this being in respect to the right to return search results for display using the application on the third party server and any subsequent replay of the selected whole or a portion of a multimedia file controlled which is accessible by the third party server.

The application referred to herein may include one or more Application Programming Interfaces (APIs) and the application is in one embodiment capable of being downloaded from the control server onto the third party server in response to the third party server requesting a search facility for multimedia for its own use or the use of users requesting searches while on the third party server. The third party server is adapted to provide a web server functionality that provides

The above description primarily supports the functions of a control server to provide a search facility, search results, and user use analytics, which identify one or more portions of multimedia files for viewing by a user and then how the user uses the portion or portions of relevance to them. The control server can use analysis tools to provide trend or trending information and that information may be on-sold to third party suppliers or made available to users as reports, alerts, social media input, or alerted to users that use certain search terms, keywords, aggregations and other identifying data (face recognition, etc.).

It is anticipated that users will want to save one or more results for future review, share those portions with others and in particular share those results using email and social media tools, such as for example Twitter, Pinterest, and Facebook, as well as professional social networking tools such as LinkedIn. The user may also command the control server to aggregate (curate) two or more of their individual search results and those can then be shared as a single link via, e.g. social media.

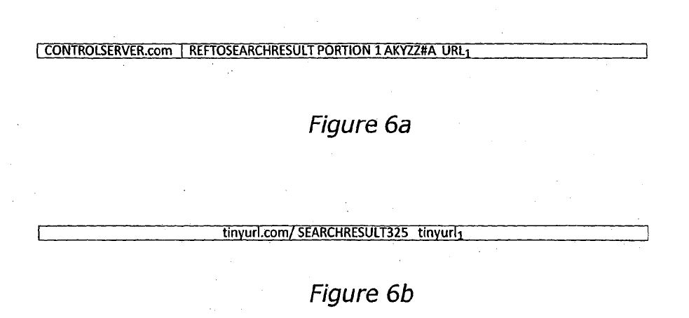

The mode by which the reference to the portion is made may vary with the sharing mechanism, and to effectively share a useable reference, it is in one embodiment, to include in the reference, at least a reference to the control server domain address in the form of a Uniform Resource Locator (URL), as depicted in FIG. 6a, so that activation of the URL by a subsequent recipient takes the recipient to the control server, and includes a reference to the search result and information which concisely describes the search result, as well, the URL may include a unique identifier of the original user that created the search and who used the search result and/or the user that has shared the search result and other identifying characteristics of the selected portion including, for example, the source, size, description, an associated image representative of the portion and various dates and times. Size limitations often apply to the types of messages that can be sent using social media, so brevity is achieved using unique references located with the URL. It is also possible to use URL shortening services available either locally to the control server or available externally of the control server to further shorten URLs, as depicted in FIG. 6b.

The social media tools available can for example, in the case, of Twitter allow for re-Tweeting of the reference to the portion, with optional comment added by the Tweeter. In the case of Facebook, the message included on a Facebook user's wall or included in a message to Facebook friends will have the above described format.

The user may want to save the reference to a particular portion of multimedia and since the user is using a browser the saving of the reference can be easily achieved by saving the reference as a bookmark the bookmark being saved as a URL (FIG. 6a).

The actual search result (which may have one or more relevant data associated with it, such as an image from the multimedia, the URL of the portion (but not the time limited version), a title, a portion of the spoken text, etc.), which has been of interest and relevance to a user having been activated by a recipient takes the recipient to the control server, which then uses the embedded reference or references to display to the recipient or user all the information described previously as associated with the search result in the form of a clickable link 140 (FIG. 2) by the control server, usually via a web browser to that recipient (who is now a potential user or previous user, or in another embodiment allows the recipient to play the relevant portion on the control server using the third party source of the portion or be served the portion from the third party server from its source). The third party suppliers' server could also provide to the control server or direct to a location on the user's computer screen, related portions, as governed by a process controlled by the third party as a suggestion mechanism or advertising. It may even be possible for sub-portions of possible relevance to be played in any media player available to the user either locally or via the control server. Clearly, the control server can also embed advertisements into the user's web based access to the control server. Such advertisements can be for goods and services, related to the user's activity.

The user can also be provided additional information in the associated web browser that allows the user to access the services supplied by the control server. The user may then rely on a subscription they already have, or the user can sign up for a subscription (that could cover a time period for unrestricted access, a selection of particular sources, a selection of particular topics, a selection of third party suppliers, a selection determined by the user from a list, etc. which is in addition to the portions of multimedia which are free), or use a one-off BUY option.

The web server functionality provided by the control server and third party server includes the provision of BUY buttons and credit card commerce functions that are not the subject of the invention but which are well within the skill of persons of skill in that art.

There can also be the option to BUY the whole of the multimedia file with contains the portion of relevance and interest to the user, or one of a number of other options, one example of which is the purchase a package which includes access to the whole collection controlled by a particular third party service supplier or to a certain collection of multimedia controlled by a particular third party, or to a package provided by the control server which permits access to a predetermined collection of third party servers and their collection of multimedia, the possibilities are many and may even vary from user to user or groups of users, or be based on from what site the user came to the control server as that may be indicative of the more likely purchase option they would sign-up to. The details for each alternative are within the skill of one skilled in the art to make available in a web browser environment to users of the respective sites.

It may also be possible for a user to store references to relevant portions of multimedia in a list available to them or to others. Such a list can be stored on the control server, a third party server, the users own computer device, or an external store such as the user's Facebook wall, Pinterest, or a user's cloud storage facility and made public or private. The reference can be stored in the form of a URL or references can be grouped, curated, or aggregated as and how the user determines which can also be made public or private.

In the case of storage in an external store such a Pinterest, it will be necessary to provide a representative image or portion of the multimedia, so that others (private, friends, or public) can add comments, recommendations, likes, and other social media like data, as the user makes their particular interests available for others to review. The provision of a reference back to the source of the multimedia, in the form of a URL that takes an interested Pinterest user to the control server is a desirable option.

The references could be played back one at a time or in a particular sequence. The references can be expanded with information obtainable from the control server or respective third party server so that the user or the recipients can be better informed. It is also possible for the control server to create a curated video file for supply to users in one or more of the many ways available.

The playing of the selected portion of the multimedia can be done on the control server or streamed from the third party server to the user's computer device. The playing of a multimedia file on the control server could involve the use of player software for every type of media but that may not be possible for a variety of technical and licensing reasons, so there will be the option of transferring the user to the source third party server or streaming of the portion via the control server.

For example, if a search result located a multimedia file such as a YouTube file and the control server did not have the ability to play the file, the YouTube server can provide a player for embedding in the control server to enable the replay of the selected portion of the file. If not, then the user is redirected to the YouTube server along with data in the directing URL, which provides relevant information, including but not necessarily all or the only information, relating to the portion of the multimedia such as the start point in the multimedia file and the length of the portion, the externally accessible address of the file and a authentication credential.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications, and substitutions without departing from the scope of the invention as set forth and defined by the following provisional claims.

The following provisional claims are provided as examples of possible claims and are not intended to limit the scope of what may be claimed in any future patent applications based on the present application. Integers may be added to or omitted from the example claims at a later date so as to further define or re-define the invention.

1. An application for execution on a third party server for providing access to multimedia file which is associated with the third party server to a user using a user client on a user computer device, wherein the application interacts with a control server from which a user client is provided the results of a respective user determined search, wherein the results of the search are associated with at least the following data, the start position of a portion of a multimedia file associated with the third party server, an authorisation credential operable to permit access to the third party server and the multimedia file content thereon, and an external address of an application on the third party server, wherein the user indicates to the control server which search result and associated data is to be provided to the user client from the externally accessible address of the multimedia file on the third party server, the application including executable code to process data associated with the user selected result, including the steps:
a) receiving from the control server a search result
b) displaying the search result to a user using the user client;
c) receiving the user selection of a result;
d) authenticating the user client to permit access by the user client to the selected multimedia file at the start position indicated by the search result;
e) communicating the selected result to the control server;
f) receiving from the control server the URL of the selected multimedia file and the start position within the selected multimedia file;
g) generating a time-limited URL for the selected multimedia file;
h) communicating the time-limited URL and start position to a media player on the user client.

2. An application according to claim 1 further including the step of:
i) recording data associated with the provision of the multimedia file including one or more details of the user interaction with the multimedia file; and
j) associating the recorded data with at least the or a part of the authorisation credential.

3. An application according to claim 2 further including the step of:
associating
k) a unique identifier of the user with the search result.

4. An application according to claim 9 further including the step of:
l) making available to the user client a search result representative of a portion of the multimedia for viewing by the user in a multimedia playback viewing area on the user computer device.

5. An application according to claim 9 further includes the step of:
m) making available the user chosen result in a user's browser initiated by the third party server permitting access to the portion of the multimedia from the third party source of the chosen result.

6. An application according to claim 1 further includes the step of:
n) collecting portions of multimedia including particular key words into an aggregated collection.

7. An application according to claim 6 further including the step of:
o) aggregating portions of multimedia including a predetermined phrase.

8. An application according to claim 7 further including the step of:
p) creating a communication to at least one user of a user client of one or more different aggregations based on the inclusion in an aggregation of a predetermined term or phrase.

9. An application for execution on a third party server for providing access to multimedia files which are associated with the third party server, wherein the user indicates to the control server which search result is to be served to the user from a third party server wherein the selected result of the search is associated within the control server with at least the following data, the start position of a portion of a multimedia file associated with the third party server, and data relating to the user client useable to permit access by the user client to the multimedia file, and an externally accessible address of the application on the third party server, the application including executable code to process data associated with the user selected result, including the steps:
a) receiving from the control server the address of the application on the third-party server and a request to serve to the user client a web page including a media player, the request including data representative of the selected result of the search;
b) authenticating the user client to permit access of the user client to the selected portion of the multimedia file at the start position indicated by the search result;
c) generating a time-limited URL for the selected portion of the multimedia file based on data representative of the search result;
d) communicating the time-limited URL and start position to a media player on the web page.

10. An application according to claim 9 further including the step of:
e) recording data associated with the provision of the multimedia file including one or more details of the user interaction with the multimedia file; and
f) associating the recorded data with at least the or a part of the authorisation credential.

11. An application according to claim 10 further including the step of:
g) associating a unique identifier of the user with the search result.

12. An application according to claim 9 further including the step of:
j) making available to the user client a search result representative of a portion of the multimedia for viewing by the user in a multimedia playback viewing area on the user computer device.

13. An application according to claim 9 further includes the step of:
k) making available the user chosen result in a user's browser intitated by the third party server permitting access to the portion of the multimedia from the third party source of the chosen result.

14. An application according to claim 1 further includes the step of:
l) collecting portions of multimedia including particular key words into an aggregated collection.

15. An application according to claim 6 further including the step of
m) aggregating portions of multimedia including a predetermined phrase.

16. An application according to claim 7 further including the step of
n) creating a communication to at least one user of a user client of one or more different aggregations based on the inclusion in an aggregation of a predetermined term or phrase.

17. A non-transitory machine-readable medium comprising a plurality of machine-readable instructions which, when executed by one or more processors, are adapted to cause the one or more processors to perform a method comprising:
a) receiving from a control server a search result;
b) displaying the search result to a user using a user client;
c) receiving the user selection of a result;
d) authenticating the user client to permit access by the user client to the selected multimedia file at the start position indicated by the search result;
e) communicating the selected result to a control server;
f) receiving from the control server the URL of the selected multimedia file and the start position within the selected multimedia file;
g) generating a time-limited URL for the selected multimedia file;
h) communicating the time-limited URL and start position to a media player on the user client.
